(19) United States
(12) Patent Application Publication
(10) Pub. No.: US 2007/0084855 A1
(43) Pub. Date: Apr. 19, 2007

(54) Cooking area, particularly a gas cooking area

(75) Inventor: Martin Oberhomburg, Wetter (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munich (DE)

(21) Appl. No.: 10/573,433

(22) PCT Filed: Sep. 23, 2004
(86) PCT No.: PCT/EP04/10684

§ 371 Date: Mar. 24, 2006

(30) Foreign Application Priority Data
Sep. 25, 2003 (EP) 03360108.9

(51) Int. Cl. H05B 1/02

(52) U.S. Cl. 219/497

(57) ABSTRACT

The invention relates to gas cooking areas comprising at least one heating element, a power controller for setting a heating output of the heating element, which operates according to the set heating output in a first operating mode or in a second operating mode, and an indicating device that indicates the set heating outputs, at which the heating element operates in the first operating mode, with symbols from a first set of symbols (1, 2, 3, 4,). In order to increase the user-friendliness when operating the cooking area, the invention provides that the indicating device indicates output stages at which the heating element operates in the second operating mode, with symbols from a second set of symbols (_, =, =) of a different symbolism.

The invention relates to a cooking area comprising at least one heating element, a power controller for setting a heating output of the heating element which operates according to the set heating output in a first operating mode or in a second operating mode, and an indicating device which indicates the set heating outputs at which the heating element operates in the first operating mode with symbols from a first set of symbols.

Known from U.S. Pat. No. 5,575,638 is a generic cooking area which can be operated in a continuous operating mode or in pulsed sequence operation. In pulsed sequence operation the burner is switched on and off in a time-controlled fashion. It is thereby possible to adjust a heating power below a minimum heating power at which the gas burner of the cooking area can still operate with a minimal continuous gas supply in the continuous mode.

Known from DE 198 02 932 is a generic cooking plate with a device for displaying an operating state of a cooking plate. As a result, in one operating state of the cooking plate a plurality of cooking stages with different cooking intensities can be selected by actuating a control device. In a further operating state of the cooking plate, a heating-up surge can be activated by actuating the control device or automatically after selecting a cooking stage.

The object of the invention is to provide a cooking area wherein user-friendly operation is ensured.

The object is solved by a cooking area having the features of claim 1. According to this, the display device indicates heating outputs at which the heating element operates in the second operating mode with symbols from a second set of symbols of a different symbolism. An allocation of the heating outputs to the two different operating modes which is easily identifiable for the user is thereby made.

It is inexpensive and visually appealing if the display device is constructed as a preferably single-digit seven-segment display. Such a conventional seven-segment display makes it possible to use a plurality of sets of symbols with only one single seven-segment display.

Such sets of symbols may mean a series of numbers from “0” to “9”, a series of letters or an arbitrary arrangement of individual segments of the seven-segment display. According to the invention, the first set of symbols can be a series of numbers from “0” to “9”. Any combinations of the seven individual segments of the seven-segment display can be used as symbols in the second set of symbols. Particularly advantageous segment combinations for the second set of symbols are obtained by using the transversely-directed segments located one above the other in the seven-segment display. By suitably controlling these three transverse segments by means of a control device, it is possible to have different power combination. The combinations of the three transverse segments can also give the user a direct indication of the level of the set power. The following display combinations by means of the three transverse segments are advantageous depending on the power level: at a low power only one transverse segment is displayed, at a moderate power two transverse segments and at a high power three transverse segments are displayed. Alternatively depending on the power level, the following display combinations by means of the three transverse segments are also possible: at a low power the lower transverse segment is displayed, at a moderate power the middle transverse segment and at a high power the upper transverse segment of the seven-segment display is displayed.

In a particular embodiment, the first operating mode is a continuous operating mode in which power is supplied continuously to the heating element. The second operating mode on the other hand is a clocked operating mode in which power is supplied to the heating element in a clocked fashion. According to the invention the clocked operating mode and the continuous operating mode are allocated symbols of different symbolism. The different symbolism of the symbols for the clocked operating mode and the continuous operating mode indicate to the user in which operating mode the heating element is operating. Any confusion as to whether there may be a fault in the heating element during an “off” time of the heating element in the clocked mode is therefore avoided.

The invention can be applied particularly advantageously to gas cooking areas with a gas burner to which gas is supplied via a gas pipe. The use of different operating modes in the power supply can be appropriate specifically in the case of gas burners. The clocked operating mode is activated at heating powers below a minimum heating power at which continuous operation of the gas burner is still possible. By means of the clocked operating mode the user can set a heating power below such a minimum heating power.

Power stages in which the heating element operates in the clocked operating mode can advantageously be shown as flashing in the display device. The set clocked operating mode is thereby additionally emphasised visually.

An exemplary embodiment of the invention is explained hereinafter with reference to the appended figures. In the figures:

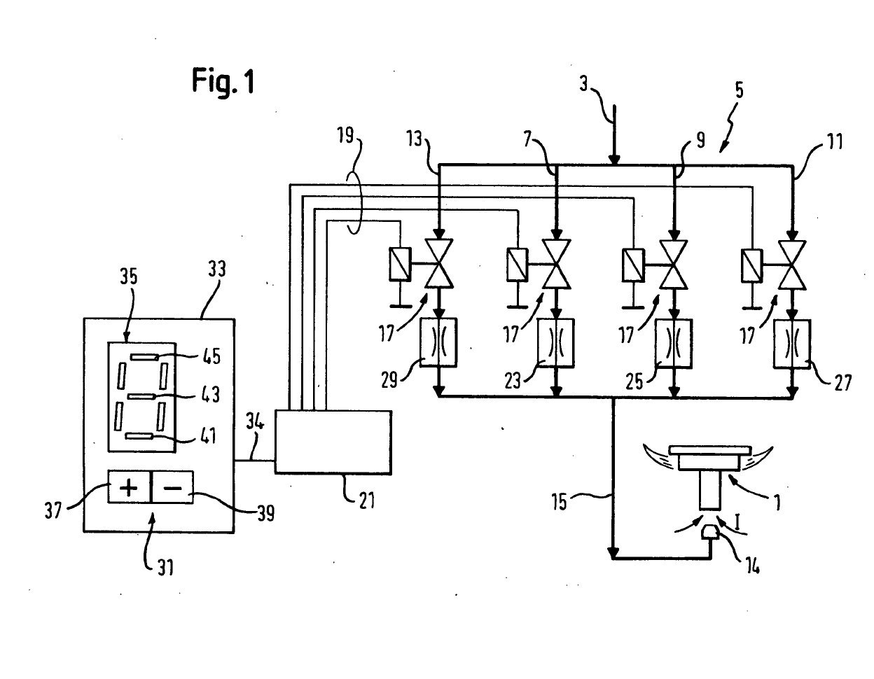

FIG. 1 is a schematic block diagram of a gas cooking area comprising a control panel, a gas valve control arrangement and a gas burner; and

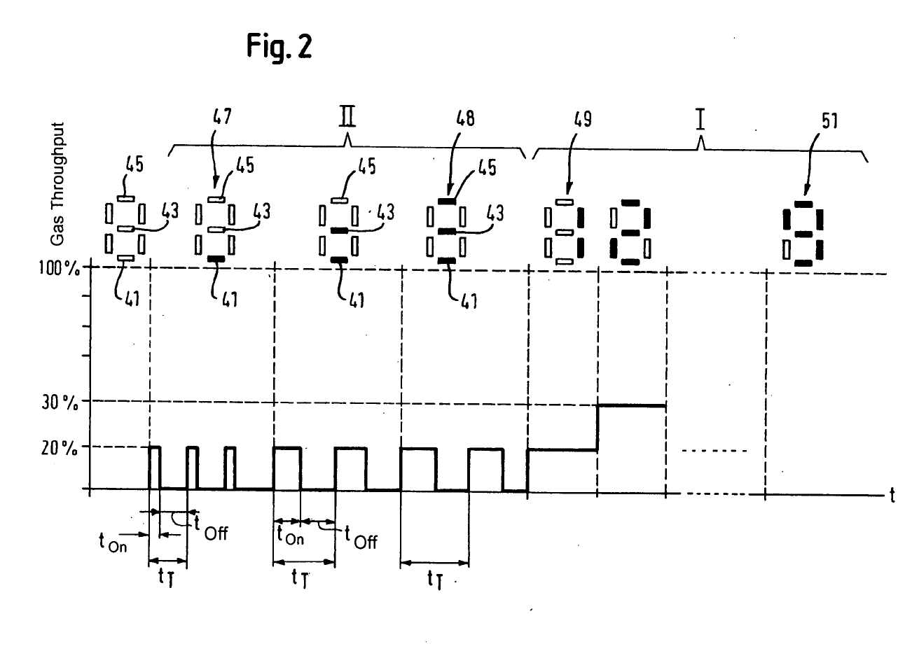

FIG. 2 is a diagram showing the gas flow rate as a function of the adjusted heating capacity stages and a respectively allocated sign which is displayed by a display device.

FIG. 1 is a highly schematic diagram showing a gas burner 1 of a gas cooking area. This is connected via a main pipe 3 to a gas pipe network. A gas valve control arrangement 5 is located in the main pipe 5. A gas throughput to the gas burner 1 is adjusted according to a desired heating power by means of the control arrangement 5. The usual safety elements for the gas cooking area such as a thermocouple and a relevant solenoid valve for safety shutdown of the gas burner if a flame goes out are not shown.

The control arrangement 5 comprises four control lines 7, 9, 11, 13 switched in parallel. These control lines branch off from the main pipe 3 and then combine again to form a burner supply line 15. This opens into a burner nozzle 14. Located in each of the control lines 7 to 13 is an electrically actuated solenoid valve 17. The solenoid valves 17 can be switched between a closed position and an open position and are controlled via signal lines 19 by means of an electronic control device 21. A user can adjust heating capacity stages of the gas burner 1 via the control device 21.

The control device 21 can control the solenoid valves 17 independently of one another. Located after the solenoid valves 17 disposed in the control lines 7, 9, 11, 13 are throttle elements 23, 25, 27, 29. The diameter of each throttle element determines its flow cross-section. If all the control lines 7, 9, 11, 13 are opened, a maximum gas throughput is fed to the burner.

The flow cross-sections of the throttle elements are designed at the factory. In this case, the first throttle element 23 passes through about 20%, the second throttle element 25 about 24%, the third throttle element 27 about 30% and the fourth throttle element 29 about 35% of the maximum gas throughput. By means of the solenoid valves 17 switched in parallel in the control lines, 16 (i.e. 2⁴) theoretically adjustable heating capacity stages with different partial gas throughputs are obtained by combinations of open and closed positions. From these nine heating capacity stages are selected at the factory and stored in the control device 21. The heating capacity stages stored in the control device 21 are adjustable by means of a power regulator 31. This is arranged in a control panel 33 and is connected to the control device 21 via a signal line 34. Also located in the control panel 33 is a display device 35 in the form of a conventional, one-digit seven-segment display. The power regulator 31 has a plus button 37 and a minus button 39.

The gas throughput of 20% of the maximum gas throughput provided by the throttle element 23 in the control line 7 corresponds to a minimal gas throughput or a minimal heating power. At the minimal heating power continuous operation of the gas burner 1 is still possible without the flame going out (minimum continuous gas throughput). When the power regulator 31 is adjusted to this minimum heating capacity stage, the control device 21 therefore permanently opens the solenoid valve 17 in the first control line 7. The solenoid valves of the other control lines on the other hand are kept closed. For heating powers below the minimum possible continuous gas throughput of 20%, the control device 21 drives the solenoid valve 17 of the control line 7 open and closed in a clocked mode. At the same time, every time the solenoid valve in the control line 7 is opened, the ignition device not shown is actuated for renewed ignition of the gas burner. Depending on the cycle times predefined by the control device 21, it is thus also possible to adjust heating powers below the minimal continuous gas throughput.

As can be seen from the diagram in FIG. 2, the power stages of the gas burner 1 can be divided into a first group I and a second group II. In the first group I the gas burner 1 operates in the continuous mode. In the second group II the gas burner 1 operates in the clocked mode. The first power stage group I is allocated symbols from a first set of symbols. The first set of symbols consists of numbers from a series of numbers from “0” to “9” which are displayed in the seven-segment display 35. The second power stage group II comprises power stages in which the gas burner operates in clocked mode. The second power stage group II is allocated symbols from a second set of symbols. The second set of symbols is obtained from combinations of the three transverse segments 41, 43, 45 of the seven-segment display 35 located one above the other. These are indicated in different numbers in the seven-segment display 35.

Operation of the gas burner 1 in the lowest power stage 47 in the clocked mode II is described hereinafter with reference to FIG. 2. The lowest power stage 47 is shown by the symbol “_” in the seven-segment display 35 in FIG. 2. In this power stage 47 of the gas burner 1 only the lower transverse segment 41 of the seven-segment display 35 is displayed according to the diagram in FIG. 2. In this case, the gas burner 1 is driven in clocked mode. In this case, an “on” time tₒₙ is 10 seconds and an “off” time t_{off} is 50 seconds in a clock interval t_{T} of one minute.

By touching the plus button 37 once, the user sets the next higher power stage which is indicated by the sign “=”. This power stage is indicated by controlling the lower transverse segment 41 and the middle transverse segment 43 of the seven-segment display 35. Alternatively, only the middle transverse segment 43 can be controlled. In this case, the “on” time tₒₙ is 20 seconds and the “off” time t_{off} is 40 seconds.

The highest power stage 48 in the clocked mode is reached by touching the plus button 37 again. The highest power stage 48 is shown in the seven-segment display 35 as “≡” with the three transverse segments 41, 43, 45 selected. Alternatively, only the upper transverse segment 45 can be selected. In the power stage 48 tₒₙ=30 seconds and t_{off}=30 seconds.

By touching the plus button 37 again, the control device 21 switches from the power stage 48 to the next higher power stage 49 which is indicated in the seven-segment display 35 by the sign “1” as shown in FIG. 2. In this power stage 49 the minimum gas supply of 20% required for continuous operation of the gas burner is fed continuously to the burner 1. The further heating powers up to the highest power stage 51 which is represented by the sign “9” and is associated with a maximum heating power of the gas burner can be adjusted in a corresponding manner by means of the power regulator 31. The minus button 39 of the power regulator 31 should be actuated to reduce the heating power of the gas burner 1 as far as the lowest heating power stage 47 with the sign “_”.

The gas burner 1 is switched on by first actuating the plus button 37 of the power regulator 31. The control device 21 then automatically adjusts the heating power stage 49 as a starting heating power stage as is indicated by the symbol “1” in FIG. 2. The continuous operating mode of the gas burner 1 is possible in the starting heating power stage 49. In this power stage 49 the minimum continuous gas supply of 20% of the maximum gas throughput ensures the continuous operating mode of the gas burner 1. Since the continuous operating mode can be adjusted at the start of the cooking process, any confusion of the user as to the operating capability of the gas burner 1 can be avoided. In the time interval t_{off} in the clocked mode of the gas burner 1, the user could incorrectly assume a burner defect at the start of the burner operation. Before switching on the gas burner 1 for safety reasons the gas cooking area can be initially activated by means of a main switch not shown.

Alternatively, the gas burner 1 can also be switched on by actuating the minus button 39. In this case, it can be advantageous if the control device 21 automatically sets the power stage 51 with the sign “9”. In this power stage 51 the gas burner 1 operates in the continuous operating mode at maximum heating power. A corresponding reduction in the heating power is effected by further actuation of the minus button 39.

In the present case the gas burner 1 is switched off by simultaneously actuating the plus button 37 and the minus button 39. Alternatively, the gas burner 1 can be switched off when the minus button 39 is pressed in the lowest power stage 47.

1-10. (canceled)

11. A cooking area comprising at least one heating element, a power controller for setting a heating output of the heating element which operates according to the set heating output in at least one of a first operating mode and a second operating mode, and an indicating device which indicates the set heating outputs in the first operating mode with symbols from a first set of symbols, wherein the indicating device indicates heating outputs in the second operating mode with symbols from a second set of symbols.

12. The cooking area according to claim 11, wherein the indicating device is embodied as a single-digit seven-segment display.

13. The cooking area according to claim 11, wherein the first set of symbols comprises a series of numbers from “0” to “9”.

14. The cooking area according to claim 12, wherein the second set of symbols comprises combinations of three transverse segments of the seven-segment display.

15. The cooking area according to claim 11, wherein the heating outputs associated with the first operating mode are grouped in a group of low heating outputs and the heating outputs associated with the second operating mode are grouped in a group of high heating outputs

16. The cooking area according to claim 11, wherein the first operating mode is a continuous operating mode in which power is supplied continuously to the heating element.

17. The cooking area according to claim 11, wherein the second operating mode is a clocked operating mode in which power is supplied discontinuously to the heating element.

18. The cooking area according to claim 11, wherein the heating element is a gas burner which is supplied with gas via a gas pipe.

19. The cooking area according to claim 18, wherein the clocked operating mode is activated at heating outputs below a minimum heating output at which the heating element is still operating with a minimal continuous supply of gas in the continuous operating mode.

20. The cooking area according to claim 11, wherein the display device displays the symbols for indicating power stages in which the heating element is operating in the clocked mode as flashing.
